(19) United States
(12) Patent Application Publication
(10) Pub. No.: US 2016/0332314 A1
(43) Pub. Date: Nov. 17, 2016

(54) AUTOMATIC SAMPLE DISPENSING DEVICE

(71) Applicant: ADHESPACK INDÚSTRIA E COMÉRCIO IMPORTAÇÃO E EXPORTAÇÃO LTDA., Sao Paulo (BR)

(72) Inventor: Volney Olivato de Camargo, Sao Paulo (BR)

(21) Appl. No.: 15/150,948

(22) Filed: May 10, 2016

(30) Foreign Application Priority Data
May 12, 2015 (BR) 10 2015 010856 7

(51) Int. Cl. B26D 1/08; B26D 5/08; B65D 83/08; B26D 5/00

(52) U.S. Cl. CPC B26D 1/085; B26D 5/007; B26D 5/086; B65D 83/0841; B65D 2583/085

(57) ABSTRACT

There is described an automatic sample dispensing device (10) comprising at least one sample holder (11) which receives at least one reel of samples (15), at least one sample holder (11) which is activated by at least one motor (12); at least one electronic module (13) which intermittently controls at least one motor (12); and one cutting element (14) placed in a cutting region (17), at least one motor (12) which rotationally activates at least one sample holder (11) and which positions at least one sample (16) in the cutting region (17), whereby at least one sample (16) is automatically detached from the sample reel (15) by the cutting element (14).

The invention refers to an automatic sample-dispensing device, used in particular to provide in a safe, hygienic and completely automatic manner unique and individual samples of products such as cosmetics, makeup and fragrances in a direct point of sale.

### DESCRIPTION OF THE PRIOR ART

In shops, fairs and other types of points of sale, consumers often request samples of the perfume or cosmetic product they wish to buy or even get to know.

When the tested product is a perfume, a small amount of the product is usually sprinkled on paper strips for the user to smell the fragrance. If the product of interest or in demonstration is a cosmetic product or makeup, there is usually a copy of the product itself called a sampler, available for consumers to withdraw small amounts. In the case of cosmetic products that are applied to the skin, the sampler products do not appear hygienic to the consumer, since he/she knows that several other individuals have already been in contact with the sampler product.

In order to minimize the problems such as the trader's loss due to offering units of sampler products and the lack of hygiene when touching sampler products, there was developed the sample dispensing element that constitutes the subject matter of document BR 102012028851. This sample-dispensing element consists of a reel provided with a plurality of samples, each sample consisting of a region for product deposit surrounded by glue portions, whereupon a protective film is placed. This sample-dispensing element is inserted into a rigid casing so that a sample handle region is available outside the rigid casing. When the consumer wishes to get a sample of the product, he/she pulls this sample by its handle until the detachable edges of the sample are torn from the edges of the next sample. To that end, the consumer needs to apply some force to pull the sample until it detaches from the reel and leaves the hard casing. Once the sample is detached, the consumer removes the protective film and has access to the material, which may be consist in perfume, cosmetics, makeup, among others.

Although this sample-dispensing element, object of document BR 102012028851, has solved the problem of products open for sampling and provides an increased level of hygiene by employing unique and individual samples which can be detached from the reels avoiding the consumer's direct contact with the sampled product, the need to pull a sample until the same detaches from the subsequent sample on the reel has required the exertion of force from the consumer and caused some discomfort thereto

### OBJECTIVES OF THE INVENTION

Thus, one objective of the present invention is that of providing an automatic sample-dispensing device that allows the consumer to obtain a unique and individual sample of a given product simply by pressing an activating button.

It also an objective of this invention to provide an automatic sample-dispensing device capable of delivering the desired sample in a completely automated way, without causing discomfort to the consumer.

Another objective of this invention is that of providing the possibility of installing the automatic sample-dispensing device in different places and/or pieces of furniture, such as counters, shelves, gondola shelves, totem poles, tables, bookshelves and various promotional equipment, either or not of a built-in type.

### BRIEF DESCRIPTION OF THE INVENTION

The object of the present invention is an automatic sample dispensing device comprising at least one sample holder which receives at least one reel of samples, at least one sample holder is activated by at least one motor; at least one electronic module which intermittently controls at least one motor; and one cutting element placed in a cutting region, at least one motor which rotationally actuates at least one sample holder and which places at least one sample in the cutting region, whereby at least one sample is automatically detached from the sample reel by the cutting element.

### BRIEF DESCRIPTION OF THE DRAWINGS

The present invention will be described in further detail in the following, based on an example of practice that is represented in the drawings. The Figures show the following:

FIG. 1—is a schematic front view of the automatic sample-dispensing device that constitutes the object of the present invention;

FIG. 2—is a schematic side view of the automatic sample dispensing device that constitutes the object of the present invention; and

FIGS. 3A and 3B—show schematic views of the sample dispensed by the automatic sample-dispensing device that constitutes the object of the present invention.

### DETAILED DESCRIPTION OF THE INVENTION

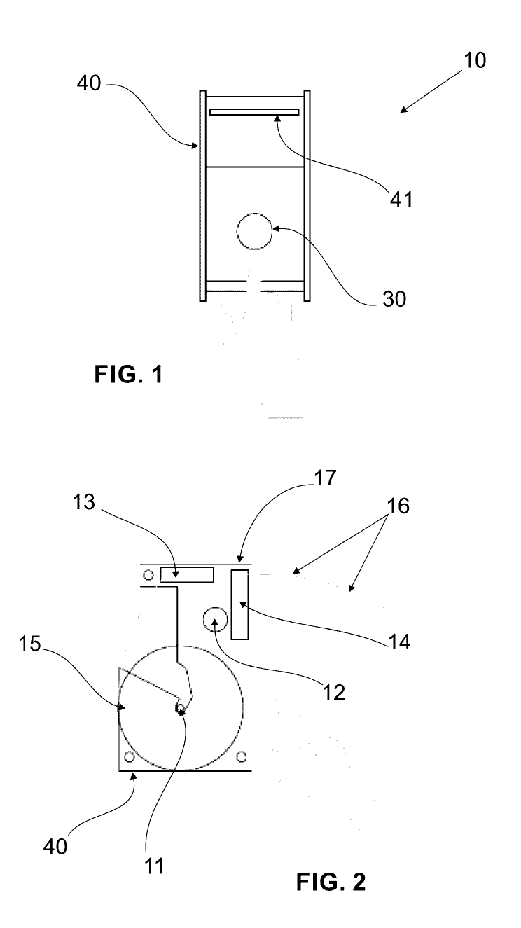

According to a preferred embodiment and as shown in FIGS. 1, 2, 3A and 3B, the automatic sample dispensing device 10, object of the present invention, consists of a rigid casing 40 preferably made of acrylic, but which may be made of another type of equivalent material.

Inside the rigid casing 40 there are provided at least one holder for samples 11, which receives at least one reel of samples 15 and is actuated by at least one motor 12, at least one electronic module 13 that commands the motor 12 and a cutting element 14, provided in a cutting region 17. The sample holder 11 consists in a shaft wherein the sample reels 15 are axially inserted.

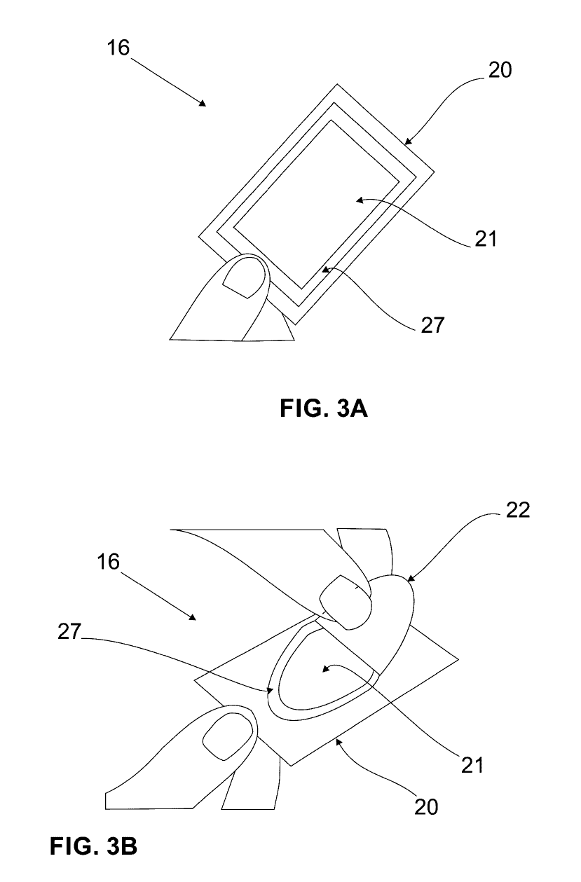

The sample reel 15 comprises a plurality of preferably equidistant printed samples 16. As may be seen in FIG. 3A, each sample 16 is provided with a rectangular or square-shaped base film 20 whereon there is a region for placement of the product 21 and an adhesive edge 27. A covering film 22 is glued to the adhesive edge 27 thus covering and protecting the sample 16, particularly the region for placement of the product 21. This covering film 22 may also have innumerous formats provided that it is suitable to cover entirely the region for placement of the product 21.

This region for product placement corresponds to the space delimited in sample 16 intended to receive products that may be fragrances, cosmetics or makeup such as lipstick, eyeshadow powder, foundation, among others. This space may have a defined shape or any shape, and furthermore the base film 20 may receive printouts and graphic elements.

Further with regard to the sample reel 15, the same may comprise more than one thousand samples 16 delimited from one another by the cutting areas 23, each cutting area 23 being arranged between two consecutive samples 16 throughout the length of the sample reel 15.

The motor 12 is an electric motor that is activated by the electronic module 13 for a predetermined period of time. Once turned on, the motor 12 rotationally actuates at least one sample holder 11 and positions at least one sample 16 in the cutting region 17. This motor 12 has the function of rotating the sample reel 15 during a given period of time in order to place the sample 16 with its cutting area 23 in the cutting region 17, on precise alignment with the cutting element 14. This cutting element 14 is preferably a guillotine 14 embedded in the rigid casing 40 next to the cutting region 17.

The electronic module 13 comprises a touch sensor and least one photocell sensor (not shown).

The touch sensor is associated with an activation button 30 and connected to an electric circuit. Upon pressing the activation button 30, a contact in the electrical circuit is closed and the electronic module 13 is activated.

In turn, the photocell sensor is activated based on markings in the sample reel 15, that is, the photocell sensor reads the markings provided on the sample reels and the data is transferred to the electronic module 13. This data transferred by the photocell sensor to the electronic module 13 indicates that the cutting area 23 of the sample 16 is coincident with the cutting region 17.

In order for the automatic sample-dispensing device to operate, the consumer touches the activating button 30 closing the contact in the electric circuit and activating the electronic module 13.

The electronic module 13 activates the motor 12 that rotates the sample reel 15 for a predetermined time. This time is adjusted so that a sample 16 is displaced out of the device 10 through a horizontal slit 41 provided in the rigid casing 40, and for the cutting area 23 of that sample to be placed next to the cutting region 17 of the device 10.

Simultaneously, during the displacement of the sample reel 15, the same passes by the photocell sensor which performs the reading of the markings in this reel 15 and sends to the electronic module 13 a signal that indicates the correct positioning of the sample 16 to be detached, that is, the correct positioning of the cutting area 23 of the sample 16 next to the cutting region 17 of the device.

When the electronic module 13 receives the information about the right positions of sample 16 through the photocell sensor, the motor 12 stops and the cutting element 14 is activated by the electronic module 13 to cut the sample 16. Thus, the sample 16 is automatically detached from the sample reel 15 and available for the consumer or user without any other action from the consumer besides touching the activation button 30.

This automatic sample-dispensing device 10 may be built-in in a totem pole, keeping apparent only the activation button 30 and the horizontal slit 41 through which the samples 15 are automatically dispensed.

In other embodiments, the automatic sample-distributing device 10 may be placed in counters, shelves, gondolas, tables, bookshelves and various promotional equipment.

Although only one preferred example of realization has been described, it should be understood that the scope of the instant invention comprehends other possible variations and that it is limited only by the content of the attached claims, including therein the possible equivalents hereof.

1. An automatic sample dispensing device wherein the device comprises:
at least one sample holder which receives at least one sample reel, the at least one sample holder configured to be activated by at least one motor;
at least one electronic module which intermittently controls the at least one motor; and
a cutting element placed in a cutting region,
the at least one motor which is configured to rotationally activate the at least one sample holder and which places at least one sample in the cutting region, the at least one sample being automatically detached from the sample reel by the cutting element.

2. A device, according to claim 1, wherein the sample reel comprises a plurality of equidistant printed samples, each one provided with a base film whereon there is a region for placement of the product covered by a covering film.

3. A device, according to claim 2, wherein the region for placement of the product receives products from among fragrances, cosmetics or makeup.

4. A device, according to claim 2, wherein the sample reel comprises a plurality of cutting areas, each cutting area being placed between two consecutive samples.

5. A device, according to claim 1, wherein the electronic module comprises a touch sensor associated with an activation button and connected to an electric circuit, the electronic module being configured to be activated by the electric circuit upon the activating button being touched.

6. A device, according to claim 1, wherein at least one electronic module is configured to activate the at least one motor for a predetermined time.

7. A device, according to claim 1, wherein the electronic module comprises at least one photocell sensor that is configured to be activated by markings on the sample reel.

8. A device, according to claim 4, wherein the electronic module is configured to receive signals from the photocell sensor when the cutting area of the sample is coincident with the cutting region.

9. A device, according to claim 1, wherein the cutting element consists of a guillotine.

10. A device, according to claim 9, wherein the guillotine is configured to be activated by the electronic module.

11. A device, according to claim 1, wherein the device comprises a rigid casing within which are inserted the at least one sample holder which receives the at least one sample reel, the at least one electronic module, the at least one motor, the cutting region and the cutting element.

12. A device, according to claim 11, wherein the rigid casing comprises a horizontal slit through which the sample is dispensed, the horizontal slit being placed next to the cutting region.
